(19) United States
(12) Patent Application Publication
(10) Pub. No.: US 2014/0337872 A1
(43) Pub. Date: Nov. 13, 2014

(54) Multimedia Interaction Method and Related Multimedia System

(71) Applicant: Cloudcity Technology Ltd., Taipei City (TW)

(72) Inventor: Chun-Yao Hou, Taipei City (TW)

(73) Assignee: Cloudcity Technology Ltd., Taipei City (TW)

(21) Appl. No.: 13/958,623

(22) Filed: Aug. 5, 2013

(30) Foreign Application Priority Data
May 9, 2013 (TW) 102116578

(51) Int. Cl. H04N 21/478; H04N 21/422; H04N 21/442

(52) U.S. Cl. CPC H04N 21/47815; H04N 21/44213; H04N 21/42207
USPC 725/18; 725/60

(57) ABSTRACT

The present disclosure provides a multimedia interaction method in a multimedia system. The multimedia system includes an electronic device and a mobile device. The multimedia interaction method includes the mobile device retrieving information associated with a multimedia program and displaying the information associated with the multimedia program when the electronic device is playing the multimedia program, and the mobile device executing a transaction process of the information associated with the multimedia program.

### BACKGROUND OF THE INVENTION

1. Field of the Invention

The present disclose relates to a multimedia interaction method and related multimedia system, and more particularly, to a multimedia interaction method and related multimedia system involved in transactions.

2. Description of the Prior Art

A portable wireless communication device, such as a smart phone, a laptop, a tablet and etc., is easy to carry and supports various types of multimedia files so it has been used widely in our daily life. As the technology has evolved, the portable wireless communication device is getting more and more powerful. Most of the portable wireless communication devices have versatile functions, such as photo shooting, recording, positioning, emailing or video or audio playing, in order to meet user's different requirements. Due to the powerful functions of the portable wireless communication device, more and more applications have been developed. For example, audiences of the TV show can vote by scanning a quick response (QR) code through a mobile phone application; customers can purchase products by scanning the QR code; mobile phone users can remotely control all kinds of home devices through the mobile phone application. Therefore, the prevalent use of the portable wireless communication devices in the daily life has been always a main goal that people have been working on.

### SUMMARY OF THE INVENTION

It is therefore an objective of the present disclosure to provide a multimedia interaction method for a multimedia system.

A multimedia interaction method for a multimedia system is disclosed. The multimedia system comprises an electronic device, a mobile device and a communication platform. The method comprises the mobile device retrieving information associated with the multimedia program and displaying the information associated with the multimedia program according to an event of the multimedia program when the electronic device is playing a multimedia program and the mobile device executing a transaction process of the information associated with the multimedia program.

A multimedia system is disclosed. The multimedia comprises an electronic device and a mobile device. The electronic device is used for playing a multimedia program. The mobile device comprises a reception unit, a display unit and an application unit. The reception unit is used for retrieving information associated with the multimedia program according to an event of the multimedia program when the electronic device is playing the multimedia program. The display unit is used for displaying the information associated with the multimedia program. The application unit is used for executing a transaction process of the information associated with the multimedia program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary flow chart of a process.

FIG. 2 is an exemplary schematic diagram of a multimedia system.

### DETAILED DESCRIPTION

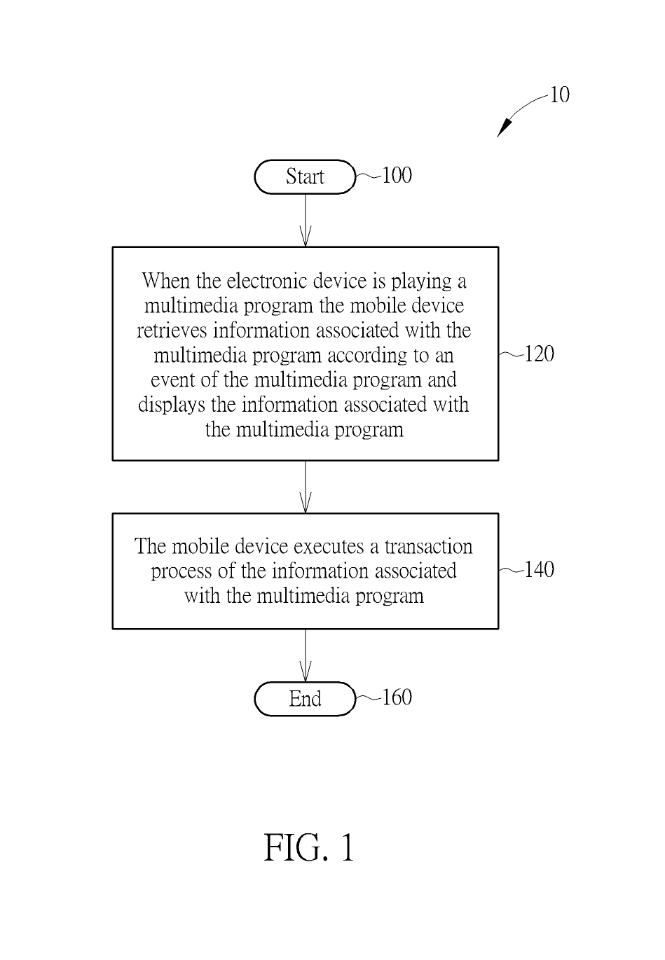

Please refer to FIG. 1, which is an exemplary flow chart of a process 10. The process 10 is a multimedia interaction method for a multimedia system. The multimedia system includes an electronic device and a mobile device. Preferably, the electronic device is a television. The mobile device could be a mobile phone, a laptop or a tablet, etc. The process 10 includes the following steps:

Step 100: Start.

Step 120: When the electronic device is playing a multimedia program the mobile device retrieves information associated with the multimedia program according to an event of the multimedia program and displays the information associated with the multimedia program.

Step 140: The mobile device executes a transaction process of the information associated with the multimedia program.

Step 160: End.

According to the process 10, when the electronic device is playing the multimedia program, the event of the multimedia program triggers the mobile device to retrieve the information associated with the multimedia program and the mobile device displays the information associated with the multimedia program on a screen of the mobile device, real-time providing the information associated with the multimedia program to the audiences who are watching the multimedia program. The event of the multimedia program, preferably, is a point in time during the multimedia program or a location where the multimedia program is being played while the information associated with the multimedia program could be product information associated with the multimedia program. Then, the mobile device triggers order information (e.g. online order) to execute a transaction process of the information associated with the multimedia program. That is, when the electronic device is playing the multimedia program the mobile device could be an auxiliary device or the second play device which helps the electronic device provide more information associated with the multimedia program to the audiences. And the audiences can have more interaction with the multimedia program through the mobile device. For example, when a television is playing a TV program, a mobile phone can retrieve product information at a certain point in time during the multimedia program and display the product information on the screen of the mobile phone, showing the information to the audiences. Or when a mobile phone user is passing by the location where a commercial is playing (e.g. in front of a screen wall or an advertisement panel), the mobile phone can retrieve the product information or the product catalogue of the commercial in real time and display the product information or the product catalogue to for pedestrians on the mobile phone screen. When the TV program audience or pedestrian retrieves the product information from the mobile phone, the TV program audience or pedestrian can place an order through the mobile phone to purchase the products. Hence, through the process 10, the mobile phone user can immediately retrieve the production information associated with the TV program which the mobile phone user is watching and execute the transaction process through the mobile phone. Besides, the information associated with the multimedia program includes not only the product catalogue but content outlines (e.g. news headlines or antecedent abstract), cast information, survey, advertisement, coupon or other information associated with the current multimedia program. For example, when a mobile phone user is watching a reality-singing competition program, the mobile can shows a list of contestants during the show and the mobile phone user can vote for his/her favorite contestant through the list displayed on the mobile phone. Or when the electronic device is only allowed to play a commercial for 15 seconds, the mobile device can play the entirely commercial of 5 minutes. In some examples, when the mobile phone user has been standing in front of the electronic device for more than 10 seconds, the mobile device can retrieve information of a 10% off coupon. Compared to prior art, the mobile phone user, according to the examples of the present disclosure, doesn't have to scan the QR code with the mobile phone, which makes operation easier for the user and increase the voting rate.

Besides, when the information associated with the multimedia program has been changed, the mobile device can immediately update the latest information associated with the multimedia program. For example, at the regular intervals (every 5 minutes or 10 minutes), the mobile device updates the latest production information if the production information has been updated. This allows the mobile phone user to get the latest production information. Meanwhile, more production information can be fed to the mobile phone user by regular update.

In some examples of the present disclosure, the multimedia system can further include a communication platform. The communication platform, preferably, is a cloud server, a website (e.g. web-based database), or a storage device (e.g. a set top box). If the communication platform is the cloud server, the process 10 can include other steps of multimedia interaction, but not limited herein. For example, the communication platform can store the information associated with the multimedia program in advance and establish a schedule. The communication platform sends the information associated with the multimedia program according to the schedule, for example, sending product information associated with a TV program A in the specific time D1 and sending production information associated with a TV program B in the specific time D2. In some examples of the present disclosure, an information identity Info_id of the multimedia program can be included in an audio signal. When the mobile device receives the audio signal, the mobile device connects to the communication platform and downloads the information associated with the multimedia program according to the information identity Info_id. Take an example, when the television is playing a TV program, the information identity Info_id of the extra production information associated with the TV program is included in an audio channel of the TV program. When the mobile phone receives the audio signal from the television via a microphone, the mobile device decodes the information identity Info_id included in the audio signal and connects to the communication platform to download the extra production information. Therefore, when a pedestrian or an audience gets the production from the mobile phone, he can place an order online and purchase the products (or retrieving the complete product information).

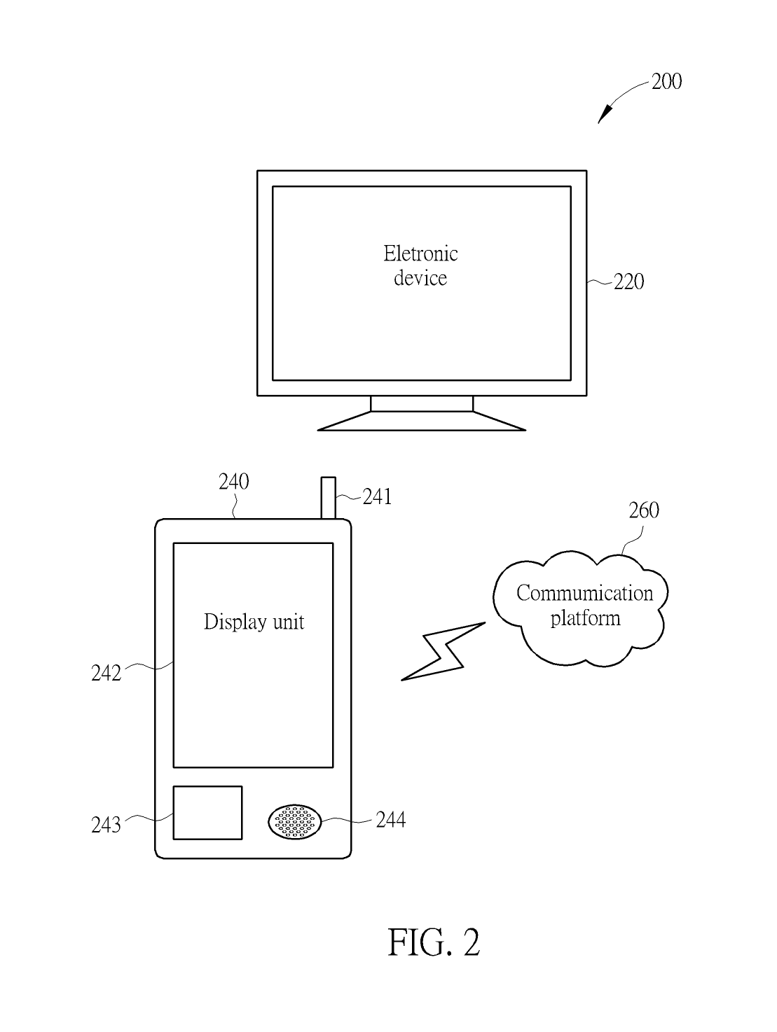

Regarding the implementation of the process 10, it is shown in FIG. 2. FIG. 2 is a schematic diagram of a multimedia system 200. The multimedia system 200 includes an electronic device 220, a mobile device 240 and a communication platform 260. Preferably, the electronic device is a television; the mobile device 240 is a smart phone, a laptop or a tablet, etc. The electronic device 220 is used for playing a multimedia program. The mobile device 240 includes a reception unit 241, a display unit 242, an application unit 243 and a microphone 244. The reception unit 241 is used for retrieving information associated with the multimedia program. The display unit 242 is sued for displaying the information associated with the multimedia program. The application unit 243 is used for executing a transaction process of the information associated with the multimedia program. The microphone 244 is used for receiving an audio signal from the electronic device 220. The communication platform 260 is used for storing the information associated with the multimedia program in advance, establishing a schedule and sending the information associated with the multimedia program according to the schedule. The communication platform 260, preferably, is a cloud server, a website (social network) or a storage device (e.g. set top box).

When the electronic device 220 is playing the multimedia program, an event of the multimedia program triggers the mobile device 240 to retrieve the information associated with the multimedia program and display the information associated with the multimedia program on the display unit 242. The event of the multimedia program could be a point in time during the multimedia program or a location where the multimedia is being played. The information associated with the multimedia program is product information, content outlines (e.g. news headlines or antecedent abstract), cast information, survey or other information associated with the multimedia program which is currently being played. The application unit 243 can trigger order information (online order) to execute the transaction process of the information associated with the multimedia program. Besides, the electronic device 220 further includes an audio output 201 which is used for broadcasting an audio signal with an information identity of the multimedia program. When the mobile device 240 receives the audio signal via the microphone 244, the application unit 243 decodes the information identity included in the audio signal and displays the information associated with the multimedia program on the display unit 242. The detailed operation of the multimedia system 200 can be found in the process 10 and aforementioned description, thus omitted herein.

To sum up, the present disclosure provides a multimedia interaction method. When the television is playing a TV program, a mobile phone can retrieve production information associated with the TV program at the specific point in time during the TV program and displays the product information, in real-time, to the audience watching the TV program on a screen of mobile phone. When the audience gets the product information, the audience can place an order online through the mobile phone, to purchase the product. Namely, the mobile phone can help the television provide more information associated with the TV program, in real-time, to the audience who are currently watching the TV program. The audiences can also purchase the products associated with the multimedia program via the mobile phone, achieving multimedia interaction.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multimedia interaction method for a multimedia system, the multimedia system comprising an electronic device, a mobile device and a communication platform, the method comprising:
the mobile device retrieving information associated with a multimedia program according to an event of the multimedia program and displaying the information associated with the multimedia program when the electronic device is playing the multimedia program; and
the mobile device executing a transaction process of the information associated with the multimedia program.

2. The method of claim 1, wherein the mobile device executing the transaction process comprise the mobile device triggering order information.

3. The method of claim 1, wherein the event is a point in time during the multimedia program or a location where the multimedia program is being played.

4. The method of claim 1, wherein the information associated with the multimedia is an outline, product information or a survey.

5. The method of claim 1 further comprising:
the communication platform storing the information associated with the multimedia program in advance;
the communication platform establishing a schedule; and
the communication platform sending the information associated with the multimedia program according to the schedule.

6. The method of claim 5, wherein the communication platform is a cloud server, a website or a storage device.

7. The method of claim 1 further comprising the mobile device immediately updating the information associated with the multimedia program when the information associated with the multimedia program has been changed.

8. The method of claim 1, wherein the electronic device is a television.

9. The method of claim 1 further comprising including an information identity of the multimedia program in an audio signal broadcast by the electronic device.

10. The method of claim 9, wherein the mobile device retrieving information associated with the multimedia program comprises:
the mobile device decoding the information identity of the multimedia program included in the audio signal;
the mobile device retrieving the information associated with the multimedia program from the communication platform according to the information identity.

11. A multimedia system comprising:
an electronic device, for playing a multimedia program; and
a mobile device comprising:
a reception unit, for retrieving information associated with the multimedia program according to an event of the multimedia program when the electronic device is playing the multimedia program;
a display unit for displaying the information associated with the multimedia program; and
an application unit for executing a transaction process of the information associated with the multimedia program.

12. The multimedia system of claim 11, wherein the application unit is further used for triggering order information.

13. The multimedia system of claim 11, wherein the event is a point in time during the multimedia program or a location where the multimedia program is being played.

14. The multimedia system of claim 11, wherein the information associated with the multimedia is an outline, product information or a survey.

15. The multimedia system of claim 11 further comprises a communication platform for storing the information associated with the multimedia program in advance, establishing a schedule and sending the information associated with the multimedia program according to the schedule.

16. The multimedia system of claim 15, wherein the communication platform is a cloud server, a website or a storage device.

17. The multimedia system of claim 11, wherein the mobile device is further used for immediately updating the information associated with the multimedia program when the information associated with the multimedia program has been changed.

18. The multimedia system of claim 11, wherein the electronic device is a television.

19. The multimedia system of claim 11, wherein the electronic device further comprises an audio output for broadcasting an audio signal which includes an information identity of the multimedia program.

20. The multimedia system of claim 19, wherein the mobile device further comprises a microphone for receiving the audio signal.

21. The multimedia system of claim 19, wherein the application unit is further used for decoding the information identity of the multimedia program included in the audio signal and retrieving the information associated with the multimedia program from the communication platform according to the information identity.
